(19) United States
(12) Patent Application Publication
(10) Pub. No.: US 2007/0152869 A1
(43) Pub. Date: Jul. 5, 2007

(54) Multichannel processing of signals in a radar system

(76) Inventors: Walter Gordon Woodington, Lincoln, MA (US); Dennis Hunt, Westford, MA (US)

Correspondence Address: VALEO RAYTHEON SYSTEMS, INC.;c/o DALY, CROWLEY, MOFFORD AND DURKEE, LLP, 354A TURNPIKE STREET, SUITE 301-A, CANTON, MA, 02021-2714, US

(21) Appl. No.: 11/323,458

(22) Filed: Dec. 30, 2005

(51) Int. Cl. G01S 13/93

(52) U.S. Cl. 342/70; 342/59; 342/159; 342/71; 342/72

(57) ABSTRACT

A vehicle radar system includes a receive antenna system which concurrently provides signals from multiple receive beams to multiple channels of a multi-channel receiver. The multi-channel receiver concurrently processes the multiple signals provided by the antenna system and provides output signals suitable for further processing. The particular arrangement may also include a transmitter which generates a single or multiple transmit beams. The number of transmit beams may be the same, less than or more than the number of receive beams. This arrangement provides a vehicle radar system which concurrently processes RF signals from multiple antenna beams. By concurrently processing RF signals from multiple antenna beams in an RF receiver, the radar system can derive more accurate information concerning detected objects.

### CROSS-REFERENCE WITH OTHER PATENT APPLICATIONS

This patent application includes aspects from the following patent applications, which are all incorporated herein by reference in their entirety: application Ser. No. ______, filed ______having Attorney Docket Number: VRS-019PUS, inventor Dennis Hunt and entitled “GENERATING EVENT SIGNALS IN A RADAR SYSTEM”; application Ser. No. ______, filed ______having Attorney Docket Number: VRS-020PUS, inventor Michael J. Gilbert and entitled “MULTI-STAGE FINITE IMPULSE RESPONSE FILTER PROCESSING”; application Ser. No. ______, filed ______having Attorney Docket Number: VRS-024PUS, inventors Dennis Hunt and W. Gordon Woodington and entitled “VEHICLE RADAR SYSTEM HAVING MULTIPLE OPERATING MODES”; application Ser. No. ______, filed ______having Attorney Docket Number: VRS-025PUS, inventor W. Gordon Woodington and entitled “REDUCING UNDESIRABLE COUPLING OF SIGNAL(S) BETWEEN TWO OR MORE SIGNAL PATHS IN A RADAR SYSTEM”; application Ser. No. ______, filed ______having Attorney Docket Number: VRS-026PUS, inventor W. Gordon Woodington and entitled “REDUCING UNDESIRABLE COUPLING OF SIGNAL(S) BETWEEN TWO OR MORE SIGNAL PATHS IN A RADAR SYSTEM”; and application Ser. No. ______, filed ______having Attorney Docket Number: VRS-014PUS, inventors Stephen P. Lohmeier and Wilson J. Wimmer and entitled “SYSTEM AND METHOD FOR GENERATING A RADAR DETECTION THRESHOLD”.

### TECHNICAL FIELD

The invention relates to radar systems and in particular to processing signals in a radar system.

### BACKGROUND

Radar systems have been developed for various applications associated with vehicles, such as automobiles, trucks and boats. A radar system mounted on a vehicle detects the presence of objects including other vehicles in proximity to the vehicle. Such a vehicle radar system may be used in conjunction with a braking system of the vehicle to provide active collision avoidance or in conjunction with a cruise control system of the vehicle to provide intelligent speed and traffic spacing control. In a further application, the vehicle radar system provides a passive indication of obstacles to a driver of the vehicle on a display. In a further application, the radar system may be mounted on other fixed or movable foundations, from which some form of surveillance of objects within the sensors few of view is required.

### SUMMARY

In accordance with the present invention, a vehicle radar system includes a receive antenna system which concurrently provides signals from multiple receive beams to multiple channels of a multi-channel receiver. The multi-channel receiver concurrently processes the multiple signals provided by the antenna system and provides output signals suitable for further processing. With this particular arrangement, a vehicle radar system which concurrently processes signals from multiple antenna beams is provided. The particular arrangement may also include a transmitter which generates a single or multiple transmit beams. The number of transmit beams may be the same, less than or more than the number of receive beams. By concurrently processing RF signals from multiple antenna beams in an RF receiver, more accurate information with respect to objects detected by the radar system can be provided. Such information includes, though not limited to, more accurate angular measurements of an objects position with respect to the sensor, than would be possible with only single channels and/or single antenna beams. Additionally processing RF signals from two or more multiple antenna beams provides information for correcting for imperfections in the antenna and receiver systems.

### DESCRIPTION OF THE DRAWINGS

FIG. 1 is a diagrammatic view of a pair of vehicles traveling along a roadway.

FIG. 2 is a block diagram of a vehicle system architecture.

FIG. 3 is a block diagram of a vehicle radar system.

FIGS. 4A and 4B are block diagrams of a portion of the vehicle radar system having a multi-channel receiver.

FIG. 5 is a flowchart of a process for processing signals in the multi-channel receiver.

FIG. 6 is a block diagram of a transmitter.

FIG. 7 is a flowchart of process for selecting frequencies.

FIG. 8 is a block diagram of a computer system on which the processes of FIG. 5 and FIG. 7 may be implemented.

FIG. 9 is a block diagram of the transmitter and a transmit antenna.

### DETAILED DESCRIPTION

Described herein is a novel approach for concurrently processing signals in multiple receive channels of a radar system. While the techniques described herein are described as used in a vehicle radar system, the techniques may be used in any radar system, either fixed or mobile.

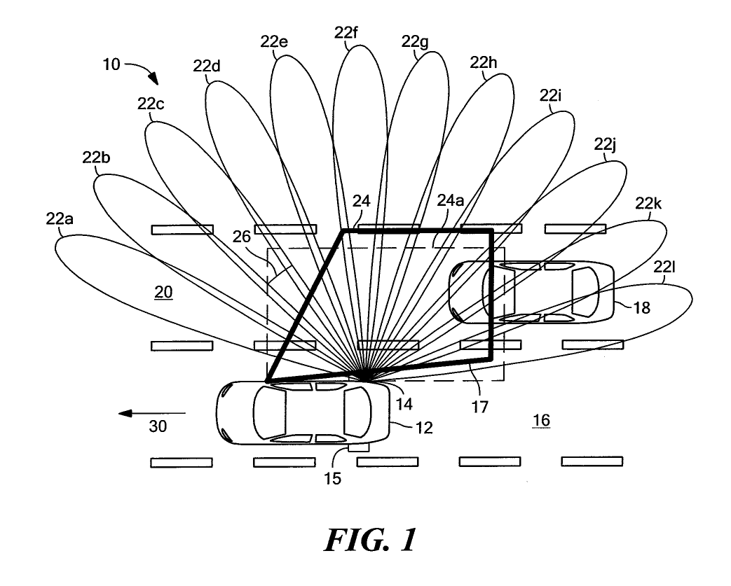

Referring to FIG. 1, a first vehicle 12 traveling in a first traffic lane 16 of a road includes a side-object detection (SOD) system 14. The SOD system 14 is disposed on a side portion of the vehicle 12 and in particular, the SOD system 14 is disposed on a right rear quarter of the vehicle 14. The vehicle 12 also includes a second SOD system 15 disposed on a side portion of a left rear quarter of the vehicle 12. The SOD systems 14, 15 may be coupled to the vehicle 12 in a variety of ways. In some embodiments, the SOD systems may be coupled to the vehicle 12 as described in U.S. Pat. No. 6,489,927, issued Dec. 3, 2002, which is incorporated herein by reference in its entirety. A second vehicle 18 travels in a second traffic lane 20 adjacent the first traffic lane 16. The first and second vehicles 12, 18 are both traveling in a direction 30 and in the respective first and second traffic lanes 16, 20.

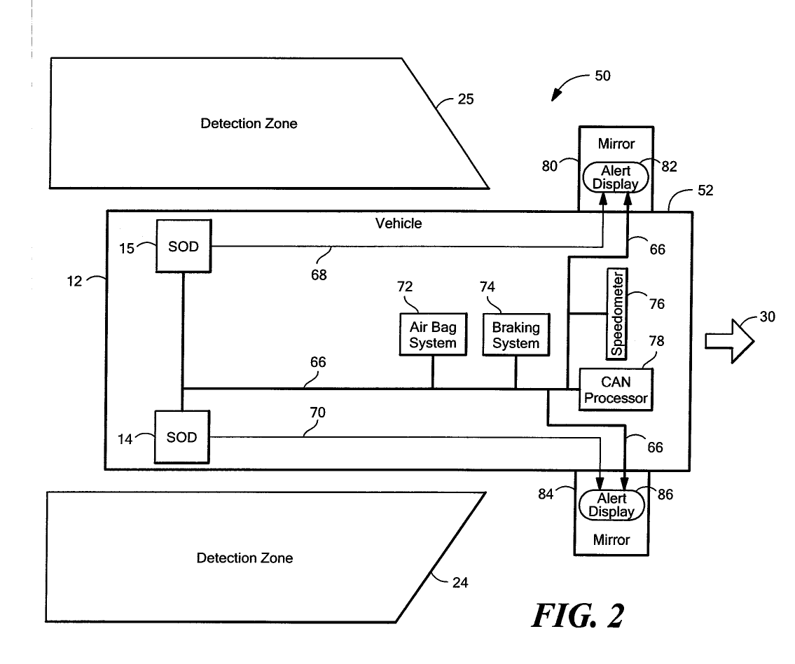

The second vehicle 18 may be traveling slower than, faster than, or at the same speed as, or in the opposite direction as the first vehicle 12. With the relative position of the vehicles 12, 18 shown in FIG. 1, the second vehicle 18 is positioned in a “blind spot” of the first vehicle 12. The blind spot is an area located on a side of the first vehicle 12 whereby an operator of the first vehicle 12 may be unable to see the second vehicle 18 either through side-view mirrors 84, 86 (see FIG. 2) or a rear-view mirror (not shown) of the first vehicle 12.

The SOD system 14 generates multiple receive beams (e.g., a receive beam 22a, a receive beam 22b, a receive beam 22c, a receive beam 22d, a receive beam 22e, a receive beam 22f, a receive beam 22g, a receive beam 22h, a receive beam 22i, a receive beam 22j, a receive beam 22k and a receive beam 22l) and an associated detection zone 24. The detection zone 24 is formed by the SOD system 14 by way of maximum detection ranges associated with each one of the receive beams 22a-22l, for example, the maximum detection range 26 associated with the receive beam 22c. Each of the receive beams 22a-22l may also have a minimum detection range (not shown), forming an edge 17 of the detection zone 24 closest to the first vehicle. The detection ranges may be adjusted to form any shape detection zone, for example, a rectangular detection zone 24a may be formed. Depending on implementation and purpose, the multiple receive beams may be of similar or different antenna patterns and of similar or different field of views. For example, but not limited to this, one receive beam may be broad such that its field of view encompasses the field of view of one or more or all of the other remaining receive beams.

In one particular embodiment, the SOD system 14 is a frequency modulated continuous wave (FMCW) radar, which transmits continuous wave chirp radar signals, and which processes received radar signals accordingly. In some embodiments, the SOD system 14 may be of a type described, for example, in U.S. Pat. No. 6,577,269, issued Jun. 10, 2003; U.S. Pat. No. 6,683,557, issued Jan. 27, 2004; U.S. Pat. No. 6,642,908, issued Nov. 4, 2003; U.S. Pat. No. 6,501,415, issued Dec. 31, 2002; and U.S. Pat. No. 6,492,949, issued Dec. 10, 2002, which are all incorporated herein by reference in their entirety.

In operation, the SOD system 14 transmits an RF signal having portions which impinge upon and are reflected from the second vehicle 18. The reflected signals are received in one or more of the receive beams 22a-22l. Other ones of the radar beams 22a-22l, which do not receive the reflected signal from the second vehicle 18, receive and/or generate other radar signals, for example, noise signals.

In some embodiments, the SOD system 14 may transmit RF energy in a single broad transmit beam (not shown). In other embodiments, the SOD system 14 may transmit RF energy in multiple transmit beams (not shown), for example, in twelve transmit beams associated with the receive beams 22a-22l.

In operation, the SOD system 14 may process the received radar signals associated with each one of the receive beams 22a-22l in sequence, in parallel, or in any other time sequence. The SOD system 14 may be adapted to identify an echo radar signal associated with the second vehicle 18 when any portion of the second vehicle 18 is within the detection zone 24. Therefore, the SOD system 14 is adapted to detect the second vehicle 18 when at least a portion of the second vehicle is in the field of view of the radar sensors on the first vehicle 12.

Referring to FIG. 2, an exemplary vehicle system 50 which may be the same as or similar to the vehicle systems included in vehicles 12,18 described above in conjunction with FIG. 1, includes vehicle systems such as SOD systems 14, 15, an air bag system 72, a braking system 74 and a speedometer 76.

Each one of the SOD systems 14, 15 is coupled to a Controller Area Network (CAN) processor 78 through a CAN bus 66. As used herein, the term “controller area network” is used to describe a control bus and associated control processor typically found in vehicles. For example, the CAN bus and associated CAN processor may control a variety of different vehicle functions such as anti-lock brake functions, air bags functions and certain display functions (visual, acoustic, or mechanical (e.g., haptic devices)).

The vehicle 12 includes two side-view mirrors 80, 84, each having an alert display 82, 86, respectively, viewable therein. Each one of the alert displays 82, 86 is adapted to provide a visual alert to an operator of a vehicle in which system 50 is disposed (e.g., vehicle 12 in FIG. 1) to indicate the presence of another vehicle in a blind spot of the vehicle). To this end, in operation, the SOD system 14 forms detection zone 24 and SOD system 15 forms a detection zone 25.

Upon detection of an object (e.g., another vehicle) and satisfying alerting criteria applied to the static position and dynamic motion of the object with respect to the detection zone 24, the SOD system 14 sends an alert signal indicating the presence of an object to either or both of the alert displays 82, 84 through the CAN bus 66. In response to receiving the alert signal, the displays provide an indicator (e.g., a visual, audio, or mechanical indicator) which indicates the presence of an object. Similarly, upon detection of an object) and satisfying alerting criteria applied to the static position and dynamic motion of the object with respect to the detection zone 25, SOD system 15 sends an alert signal indicating the presence of another vehicle to one or both of alert displays 82, 86 through the CAN bus 66. However, in an alternate embodiment, the SOD system 14 may communicate the alert signal to the alert display 82 through a human/machine interface (HMI) bus 68. Similarly, SOD system 15 may communicate the alert signal to the other alert display 86 through another human/machine interface (HMI) bus 70.

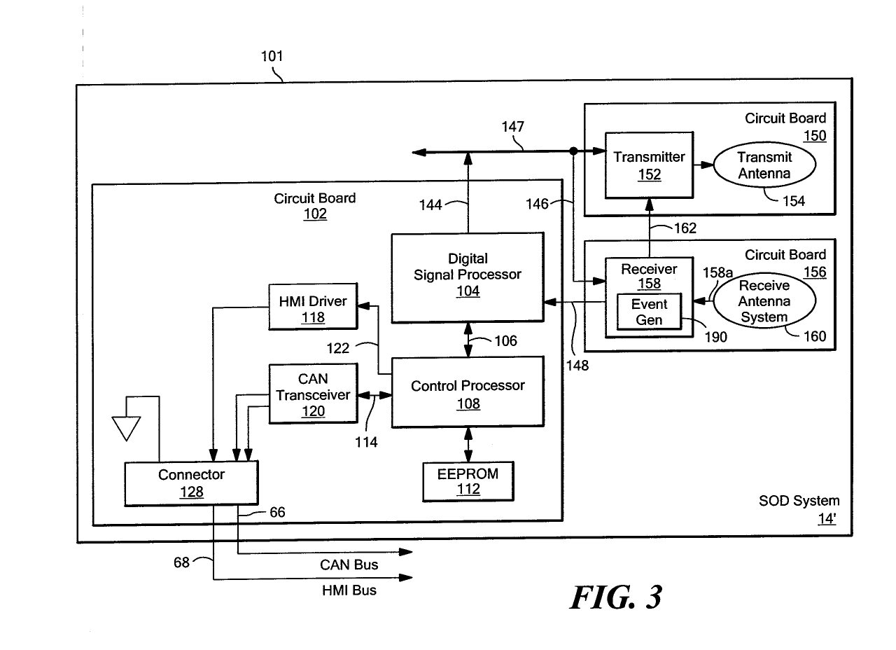

Referring to FIG. 3, a SOD system 14′ which may be the same as or similar to SOD 14 described above in conjunction with FIGS. 1 and 2, includes a housing 101, in which a fiberglass circuit board 102, a polytetrafluoroethylene (PTFE) circuit board 150, and a low temperature co-fired ceramic (LTCC) circuit board 156 reside. In other embodiments, circuit board 150 may be a LTCC. In other embodiments, circuit board 150 may be a hydrocarbon material.

The fiberglass circuit board 102 has disposed thereon a digital signal processor (DSP) 104 coupled to a control processor 108. The control processor 108 is adapted to perform control logic functions, for example, to identify conditions under which an operator of a vehicle on which the SOD system 14 is mounted should be alerted to the presence of another object such as a vehicle in a blind spot.

The control processor 108 is coupled to an electrically erasable read-only memory (EEPROM) 112 adapted to retain a variety of values including but not limited to calibration values. Other read only memories associated with processor program memory are not shown for clarity. The control processor 108 is coupled to a CAN transceiver 120, which is adapted to communicate, via a connector 128, on the CAN bus 66.

The control processor 108 is coupled to an optional human/machine interface (HMI) driver 118, which may communicate via the connector 128 to the HMI bus 68. The HMI bus 68 may include any form of communication media and communication format, including, but not limited to, a fiber optic media with an Ethernet format, and a wire media with a two state format.

The PTFE circuit board 150 includes a radar transmitter 152, which is coupled to the DSP 104 through a serial port interface (SPI) 147 and a bus 144, and a transmit antenna 154, which is coupled to the radar transmitter 154.

The LTCC circuit board 156 includes a receiver 158, which is coupled to the DSP 104 through the SPI 147 and a bus 146, and a receive antenna system 160, which is coupled to the radar receiver 158. The radar transmitter 152 and the radar receiver 158 may receive the regulated voltages from the voltage regulator 134.

In operation, the DSP 104 initiates one or more chirp control signals (also referred to as ramp signals) by providing a command signal to an event generator 190. In response to the command signal from the DSP, the event generator 190 generates the chirp control signals. Thus, the event generator removes the chirp control signal processing function from the DSP 104. In the embodiment of FIG. 3, the chirp generator is located in the receiver 158. In other embodiments, however, the event generator 190 can be located in other portions of the radar system 14′ (FIG. 1). The event generator is described in co-pending patent application entitled GENERATING EVENT SIGNALS IN A RADAR SYSTEM, filed on the same date herewith and having named inventors Dennis Hunt, identified by attorney docket number VRS-019PUS, assigned application Ser. No. ______and assigned to the assignee of the present invention and is hereby incorporated herein by reference in its entirety.

It should be understood that by removing the control signal waveform responsibility from the DSP 104 and providing an event generator circuit which is separate from the DSP, the event generator is able to provide more flexibility in defining controllability and defining chirp control signals. This is because the DSP must serve multiple and differing types of requests while the event generator serves only to generate control signals related to generation of the chirp control signals. The required accuracy of the timing signals generated by the event generator also precludes it from being a direct responsibility of the DSP 104. Also, the DSP 104 is now freed from this time consuming activity, so it can now perform additional critical tasks in parallel.

The transmit antenna 154 may be provided having one or a plurality of transmit beams. Regardless of the number of transmit beams, the transmit antenna 154 emits RF chirp radar signal in a desired field of views (e.g., summed or individually covering the detection zone 24 in FIG. 1). The transmit beams may be similar or different in antenna pattern and may be similar or different in fields of view. Their fields of view may overlap to varying extents, from completely to not a all.

The receive antenna system 160 may be provided having one or a plurality of receive beams. The receive beams may be similar or different in antenna pattern and may be similar or different in fields of view. Their fields of view may overlap to varying extents, from completely to not a all. The SOD 14 in FIG. 1, for example, utilizes twelve receive beams 22a-22l. Each of the receive beams receives return or echo radar signals, or otherwise generates and/or receives noise signals. Signals received through the receive beams are directed to the radar receiver 158. The radar receiver 158 receives the signals provided thereto from the antenna, down converts the received RF signals to an intermediate frequency (IF) signal, and provides an output signal on signal path 148. In addition to the frequency down conversion, the receiver 158 appropriately processes the RF input signals provided thereto from the receive antenna system 160 such that the output signals on signal path 148 can be appropriately received and processed by the DSP 104.

The signal provided to the input of DSP 104 has a frequency content, wherein signal level peaks which occur at different frequencies represent detected objects at different ranges. The DSP 104 analyzes the signals provided thereto and identifies objects in the detection zone 24. One particular technique for identifying objects is described in U.S. patent application Ser. No. 11/102,352, filed Apr. 8, 2005 which is incorporated herein by reference in its entirety.

Some objects identified by the DSP 104 may be objects for which an operator of the first vehicle 12 (FIG. 1) has little concern and need not be alerted. For example, an operator of vehicle 12 may not, in some instances, need to be alerted as to the existence of a stationary guardrail along the roadside. Thus, criteria additional to the presence of an object in or near the detection zone may be used to determine when an alert signal should be generated and sent to the operator.

To utilize further criteria, the control processor 108 receives object detections on a bus 106 from the DSP 104. The control processor 108 applies a series of factors and characteristics (i.e., criteria used in addition to that used by DSP 104 to identify an object) to control generation of an alert signal. For example, upon determination by the control processor 108, the alert signal may be generated and sent through a bus 114 to CAN transceiver 120 and communicated on the CAN bus 66, which is indicative not only of an object in the detection zone 24, but also is indicative of an object having predetermined characteristics being in the detection zone. In other embodiments, an alert signal may be communicated by control processor 108 on a bus 122 through the HMI driver 118 to the HMI bus 68.

The fiberglass circuit board 102, the PTFE circuit board 150, and the LTCC circuit board 156 are comprised of materials which present known characteristics for signals within particular frequency ranges. It is known, for example, that fiberglass circuit boards have acceptable signal carrying performance at signal frequencies up to a few hundred megahertz (MHz). LTCC circuit boards and PTFE circuit boards are know to have acceptable signal carrying performance at much higher frequencies. Thus, taking into consideration cost and performance characteristics, the lower frequency functions of the SOD system 14 are disposed on the fiberglass circuit board 102, while the functions having frequencies in the radar range of frequencies (e.g., 2 GHz) are disposed on the LTCC and on the PTFE circuit boards 150, 156, respectively. Nevertheless other suitable materials may be used.

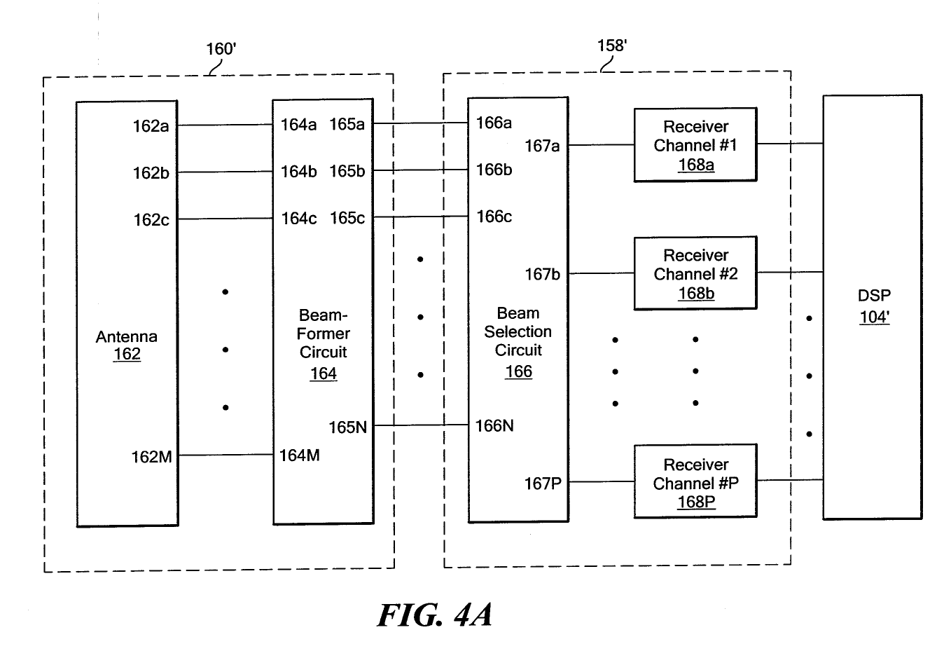

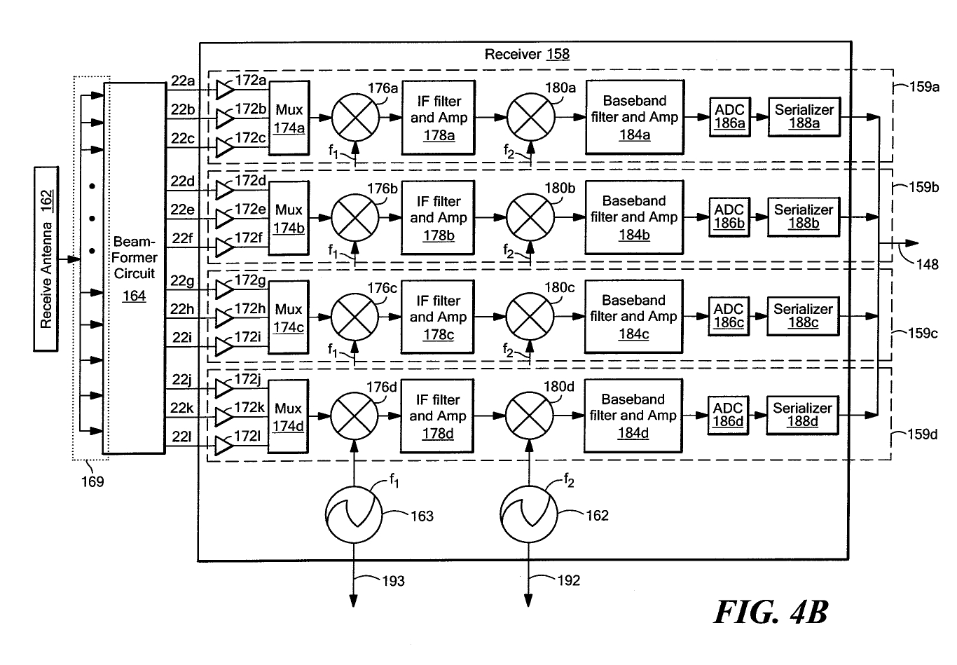

Referring now to FIG. 4A, in general overview, RF radar signals are received via a receive antenna system 160′ which may be the same as or similar to receive antenna system 160 described above in conjunction with FIG. 3. The antenna system 160′ concurrently provides RF signals from multiple RF beams to multiple channels of a multi-channel receiver 158′. Receiver 158′ may be the same as or similar to the receiver 158 described above in conjunction with FIG. 3. The multi-channel receiver 158′ concurrently processes the multiple RF signals provided thereto and provides output signals to a digital signal processor 104′ which may be the same as or similar to DSP 104 in FIG. 3. By concurrently processing RF signals from multiple antenna beams in an RF receiver, more accurate information with respect to objects detected by the radar system can be provided. This information includes though not limited to more accurate estimates of the position and extent of single and multiple objects and of the range position within the field of view of the sensor, as well as information that compensates for limitations of the antenna and other subparts of the sensor, such as sibelobe cancellation and noise floor thresholding.

In detail, antenna system 160′ includes an antenna 162 having a plurality of antenna ports 162a-162M. The antenna ports are coupled to the beam-former circuit 164 at respective ones of beam-former circuit input ports 164a-164M. In one embodiment, the beam-former circuit 164 can be provided as Butler Matrix beam-former circuit. Thus, each of the antenna ports 162a-162M is coupled to a corresponding one of the beam-former circuit input ports 164a-164M. The beam-former circuit 164 receives the signals fed thereto from the antenna 162 and concurrently provides antenna beam signals at beam-former circuit output ports 165a-165N.

Thus, the beam-former circuit 164 illustrated in FIG. 4A forms N beams (i.e., one beam on each of the beam ports 165a-165N). It should be appreciated that although the beam-former circuit 164 is here shown to provide N antenna beams, the beam-former circuit 164 can be selected such that it forms any desired number of antenna beams. In one form the connection from beam-former circuit input (one of 164a-164m) to its output (one of 165a-165N) may be a direct unbranched connection, and/or may be by connection through, for example, a Butler Matrix.

In particular, the receive beams are coupled from beam-former circuit beam ports 165a-165N to input ports 166a-166N of a beam selection circuit 166. Thus, each of the beam selection circuit input ports 166a-166N are coupled to a corresponding one of the beam-former circuit output ports 165a-165N.

The beam selection circuit 166 receives the beams provided thereto from the beam-former circuit 164 and functions so as to couple one beam from beam ports 167a-167P to each of a different receiver channels 168a-168P. Thus, each receiver channels 168a-168P is effectively coupled to a corresponding one of the beam ports 167a-167P. It should be appreciated that the particular beams which the beam selection circuit 166 couples to the receiver channels 168a-168P depends, in part, upon the number of receiver channels in the multi-channel receiver 158′.

For example, if the number of channels in the receiver 158′ equals the number of beams formed by the beam-former circuit 164, then each beam is coupled to a corresponding receiver channel. Since each antenna beam is coupled to a receiver channel, then all information received by the antenna system 160′ can be processed by the receiver concurrently. This one-receiver-channel-per-one-antenna-beam approach, however, may typically not be practical in realistic systems due to cost and size limitations. Thus, practical systems may or may not utilize such an approach.

Thus, another approach would be to provide a receiver having a number of receiver channels which is less than the number of beams formed by the beam-former circuit (e.g., the beam-former circuit 164 forms eight beams and the receiver 158′ includes four receiver channels). In this case, the beam selection circuit 166 would couple selected ones of the beams to the receiver channels (e.g., four of the eight beams would be coupled to the receiver at any one instant in time). The information (in the form of RF signals) received via each selected beam (e.g., each of the four selected beams) would be concurrently processed in the respective receiver channel (e.g., each of the four receiver channels). Thus, the receiver 158′ would concurrently process the information in each receiver channel. One example of this approach (i.e., a number of receiver channels which is less than the number of beams formed by the beam-former circuit) is described below in conjunction with FIG. 4.

Regardless of the specific number of channels in the receiver 158′, the receiver concurrently processes the signals fed to each receiver channel and provides the processed signals to a digital signal processor (DSP) 104′. DSP 104′ may be the same as or similar to DSP 104 described above in conjunction with FIG. 3.

It should be appreciated the above description of the beam-former circuit 164 as being part of the antenna system 160′ and the description of the beam selection circuit 166 as being part of the receiver 158′ is somewhat arbitrary. That is, in some embodiments, both the beam-former circuit 164 and the beam selection circuit 166 may be considered as part of the receiver 158′ while in other embodiments both the beam-former circuit 164 and the beam selection circuit 166 may be considered as part of the antenna system 160′. Alternatively still, in some embodiments the beam selection circuit 166 may be provided as part of the antenna system 160′ and the beam-former circuit 164 may be provided as part of the receiver 158. Furthermore, in some embodiments, the beam-former circuit 164 and the beam selection circuit 166 may be provided as physically separate circuits while in other embodiments, the beam-former circuit 164 and the beam selection circuit 166 may be provided as a single circuit having the same overall functionality provided by the two circuits individually. In short, the multi-channel processing approach described herein is not dependent upon the particular location of any of the circuits nor the particular manner in which any of the circuits are implemented.

It should be appreciated that the system described in FIG. 4A utilizes detected signals to locate objects.

Referring now to FIG. 4B, RF radar signals are received at receive antenna system 160 and coupled as RF signals 169 to a beam-former circuit 164 which generates the RF received beams 22a-22l at beam ports thereof. It should be appreciated that although beam-former circuit 164 is here shown as providing twelve beams 22a-22l, in alternate embodiments, the beam-former circuit 164 can provide fewer or more than twelve beams. For example, in alternate embodiments, the beam-former circuit 164 can provide seven, eight or nine beams. In other embodiments, the beam-former circuit 164 can provide fifteen, sixteen or N beams. Thus, the principles of concurrently processing antenna beam signals in multiple channels of a multi-channel receiver can be applied to any number of beams and any number of receiver channels greater than one.

The receive beams 22a-22l are coupled from the beam-former circuit to a multi-channel receiver 158. In this exemplary embodiment, the receiver 158 includes receiver channels (e.g., a receiver channel 159a, a receiver channel 159b, a receiver channel 159c and a receiver channel 159d). Each of the receiver channels 159a-159d receives the RF signals from the beam-former circuit 164. The particular manner in which the beams 22a-22l are coupled to respective ones of the receiver channels 159a-159d will be explained further below. Suffice it here to say that each of the receiver channels 159a-159d performs a frequency down-conversion on RF signals provided thereto to provide intermediate frequency (IF) signals, filters the IF signals and converts the signals to digital samples. The digital samples are provided at an output 148 of the receiver. The signals at receiver output 148 are available for further processing (e.g., for processing by the DSP 104 in FIG. 3).

Taking receiver channel 159a as exemplary of each of the receiver channels 159b-159d, beams 22a-22c are coupled from the beam-former circuit 164 to input ports of low noise amplifiers (LNAs) 172a-172c in receiver channel 159a. The output ports of the LNAs 172a-172c are coupled to the input ports of a multiplexer (MUX) 174a. It should be appreciated that in some embodiments, the MUX input ports may be coupled directly to the beam-former circuit 164 and a single LNA can be disposed at the MUX output port.

At any one instant of time, the multiplexer 174a couples a selected one of the LNA output ports 172a-172c to an RF input port of a first frequency down converter circuit 176a. Thus, at any one instant of time, the multiplexer 174a effectively couples one of the antenna beams 22a- 22c the receiver channel 159a. The unselected ones of beams 22a-22c are unused by the receiver channel 159a while the selected beam is processed. For example, if MUX 174a selects antenna beam 22a for processing in the receiver channel 159a, then the information received in beams 22b and 22c is not being used during the processing of information received via beam 22a in receiver channel 159a.

The down converter 176a receives the RF signal from the MUX 174a and a first local oscillator (LO) signal having a frequency f₁, from a first signal source 163. In response to the RF and LO signals provided thereto, the first down converter 176a provides a first intermediate frequency (IF) signal to an input of an IF filter and amplifier circuit (IFAC) 178a. The IFAC 178a appropriately amplifies and filters the signals fed thereto and provides the amplified and filtered signals to an RF port of a second frequency down converter circuit 180a.

The second down converter 180a receives the first IF signal from the IF filter and amplifier circuit 178a and a second LO signal having a frequency f₂ from a second signal source 162. In response to the signals provided thereto, the second down converter 180a provides a second intermediate frequency (IF) signal to an input of a baseband filter and amplifier circuit (BPAC) 184a. The BPAC 184a appropriately amplifies and filters the signals fed thereto and provides the amplified and filtered signals to an input port of an analog-to-digital converter (ADC) 186a.

The ADC 186a converts the analog signals fed thereto to a stream of digital bits and provides the bit stream to serializer 188a. The serializer 188a provides the digital bits to other processing elements of the radar system (e.g., DSP 104′ in FIG. 4A and DSP 104 in FIG. 4B).

The receive channels 159b-159d include similar functional components as receive channel 159a. For example, receive channel 159b includes a MUX 174b, a first down converter 176b, an IFAC 178b, a second down converter 180b, a BFAC 184b, an ADC 186b and a serializer 188b; receive channel 159c includes a MUX 174c, a first down converter 176c, an IFAC 178c, a second down converter 180c, a BFAC 184c, an ADC 186c and a serializer 188c; and receive channel 159d includes a MUX 174d, a first down converter 176d, an IFAC 178d, a second down converter 180d, a BFAC 184d, an ADC 186d and a serializer 188d.

Thus, with respect to the receiver channels 159b-159d, each of the LNAs 172d-172l receives a respective receive beam (e.g., the LNA 172d receives the receive beam 22d, the LNA 172e receives the receive beam 22e, the LNA 172f receives the receive beam 22f and so forth). Each LNA 172d-172l provides an amplified version of its respective beam to a corresponding multiplexer 174b-174d such that each of the multiplexers 174b-174d connects to three corresponding LNAs (e.g., the LNA 172d, the LNA 172e and the LNA 172f connect to the multiplexer 174b; the LNA 172g, the LNA 172h and the LNA 172i connect to the multiplexer 174c; and the LNA 172j, the LNA 172k and the LNA 172l connect to the multiplexer 174d).

Thus, in this particular embodiment, each of the receiver channels 159a-159d can process information from one of a possible three beams. That is, as described above channel 159a can process information from any of beams 22a-22c ; similarly, channel 159b can process information from any of beams 22d-22f; channel 159c can process information from any of beams 22g-22i ; and channel 159d can process information from any of beams 22j-22l. Moreover, since each of the selected beams is coupled to its own receiver channel (i.e., one of channels 159a-159d), the information in each of the selected beams is processed concurrently in the receiver 158.

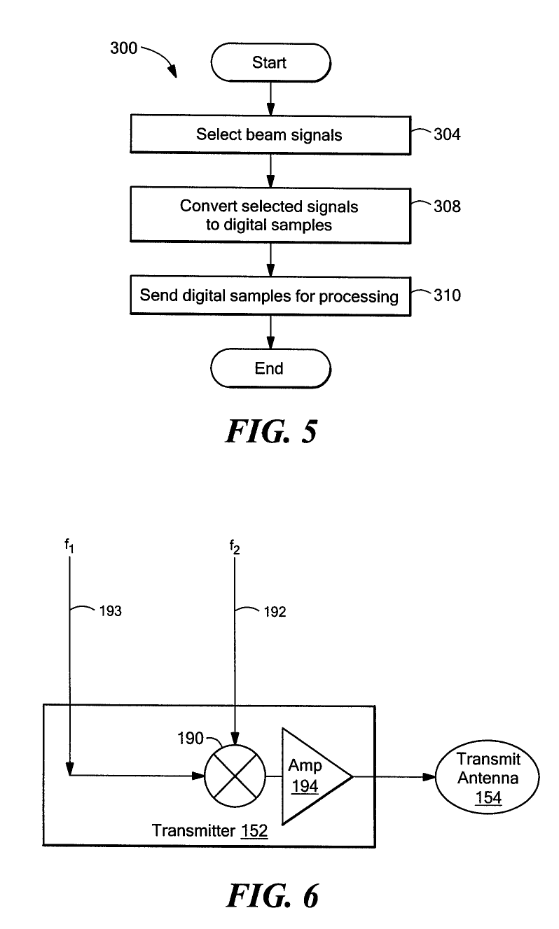

Referring to FIG. 5, an exemplary process for concurrently processing multiple RF signals received in multiple antenna beams which can be used by receiver 158 FIG. 4A for example begins by selecting the receive beams (e.g., 22a-22l in FIG. 4B) for down-conversion (304). For example, the MUXes 174a-174d select one of the three respective received beams 22a-22l received for further processing. For example, the MUX 174a selects either the receive beam 22a, the receive beam 22b or the receive beam 22c ; the MUX 174b selects either the receive beam 22d, the receive beam 22e or the receive beam 22f; the MUX 174c selects either the receive beam 22g, the receive beam 22h or the receive beam 22i; and the MUX 174d selects either the receive beam 22j, the receive beam 22k or the receive beam 22l. Thus, the receiver 158 processes four of the twelve receive beams 22a-22l concurrently.

Process 300 down-converts the selected receive beam signals from RF frequencies (e.g., 24 GHz) to frequencies which are appropriate for converting signals to digital samples (308). For example, a receive beam signal 22a, 22b or 22c selected by the MUX 174a is down-converted by the first down converter 176a using the first signal source frequency f₁, which uses, for example, a first local oscillator (LO) signal from signal source 163. Illustrative frequencies for the receive beam signals selected by the MUX 174a and the first signal source f₁, are on the order of 24 GHz and 17.5 GHz, respectively. In one embodiment, the first signal source f₁ is a chirp oscillator with a frequency modulating between 17.4 GHz to 17.6 GHz and together with the first down converter 176a the received signal is de-chirped.

The first down converter 176a provides a down-converted or intermediate frequency (IF) signal to the IFAC 178a. The IFAC 178a provides a suitably filtered and amplified version of the down-converted signal fed thereto to the second down converter 180a. The signal from the IFAC 178a is fed to the second down converter 180 where it is further down-converted using a second LO signal having a frequency f₂, for example, provided by the second signal source 162 (FIG. 4B). Illustrative frequencies for the IF signals from the IFAC 178a and the second signal source f₂ are on the order of 6.5 GHz. In one embodiment, the second signal source f₂ is a fixed oscillator with a fixed oscillation of 6.5 GHz.

Thus, in one another embodiment, it is preferred that a chirp signal is used in down-converting at the first down converter 176a before down-converting with a fixed frequency signal at the second down converter 180a to reduce the artifacts introduced by the first signal source f, when providing a chirp oscillation signal. In a further embodiment, it is preferred that the first down converter down-convert with the larger frequency of the two LO signals due to the hardware expense in providing amplification in IFAC 178a.

The second down converter 180a provides the second down-converted or IF signal to the BFAC 184a. The BFAC 184a provides a suitably filtered and amplified signal to the ADC 186a. The ADC 186a converts the analog signal into digital signal samples which are serialized by a serializer 188a.

Process 300 sends the digital samples from each channel to be further processed (310). For example, the serializers 188a-188d send their respective digital samples to the DSP 104 (FIG. 3) through the bus 148 which processes the digital samples fed thereto to determine the content of the return signal within various frequency ranges.

Referring to FIG. 6, transmitter 152 includes a frequency up-converter circuit or mixer 190 and an amplifier 194. The mixer 190 receives a first signal from the first signal source 163 (FIG. 4) having frequency f₁ through signal path 193 and the second signal from the second signal source 162 having frequency f₂ through the signal path 192. The mixer 190 up-converts the first and the second signals at frequencies f₁ and f₂, respectively, to form a transmit signal having a frequency f₃ (where f₃=f₁+f₂). The transmit signal having frequency f₃ is further amplified by the amplifier 194 and subsequently coupled to and emitted through the transmit antenna 154.

It should be appreciated that receiver 158 in FIG. 4B utilizes a double-down conversion scheme and thus the receiver is said to have a double heterodyne receiver architecture. By utilizing a double-down conversion scheme in the receiver and an up-conversion scheme to provide an RF transmit signal to the transmitter, a system having a reduced amount of undesirable coupling of signal(s) between the receiver 158 and the transmitter 152 can be provided. This is because the frequencies of the signals used to provide the first and second local oscillator signals can be appropriately selected so as to avoid interference with the frequency of the transmit signal.

For example, if the first signal from the first signal source 163 is provided having a frequency f₁ of 17.5 GHz and the second signal from the second signal source 162 is provided having a frequency f₂ of 6.5 GHz, the combined frequency that is transmitted from the transmit antenna is 24 GHz. Since the signal path 193 carries the first signal of 17.5 GHz and the signal path 192 carries the second signal of 6.5 GHz, these signals do not interfere with the 24 GHz signals being transmitted and received.

In one embodiment, the first signal source 163 is provided as a chirp oscillator with a frequency modulating from 17.4 GHz to 17.6 GHz, the second signal source 162 is provided as a fixed oscillator with a fixed oscillation frequency of 6.5 GHz. When these two signals are combined in the mixer 190, a chirped transmission signal is provided.

It should be appreciated that although reducing undesirable coupling of signal(s) between two or more signal paths may result from using a double heterodyne receiver to receive signals and an up-conversion scheme to provide an RF transmit signal and appropriately selecting the frequencies of operation, a receiver which uses more than two frequency down-conversions may also be used. It should be appreciated, however, that using additional down conversions in the receiver may lead to additional expense (due to the need for additional down converter circuits as well as the possible need for additional signal sources to provide LO signals for each of the down converter circuits. Thus, use of more than two down-converter circuits in an RF receiver is generally not preferred. Similarly, additional up-conversions to produce a transmit signal may also be used and this also can result in increased isolation between transmit and receive signals. Thus, increased isolation between transmit and receive signals may be achieved by using a receiver architecture which utilizes multiple down-conversion circuits and selecting an up-conversion circuit architecture which cooperates with the selected receiver architecture and which includes one or more up-conversion circuits which produce RF transmit signals having desired RF transmit signal frequencies.

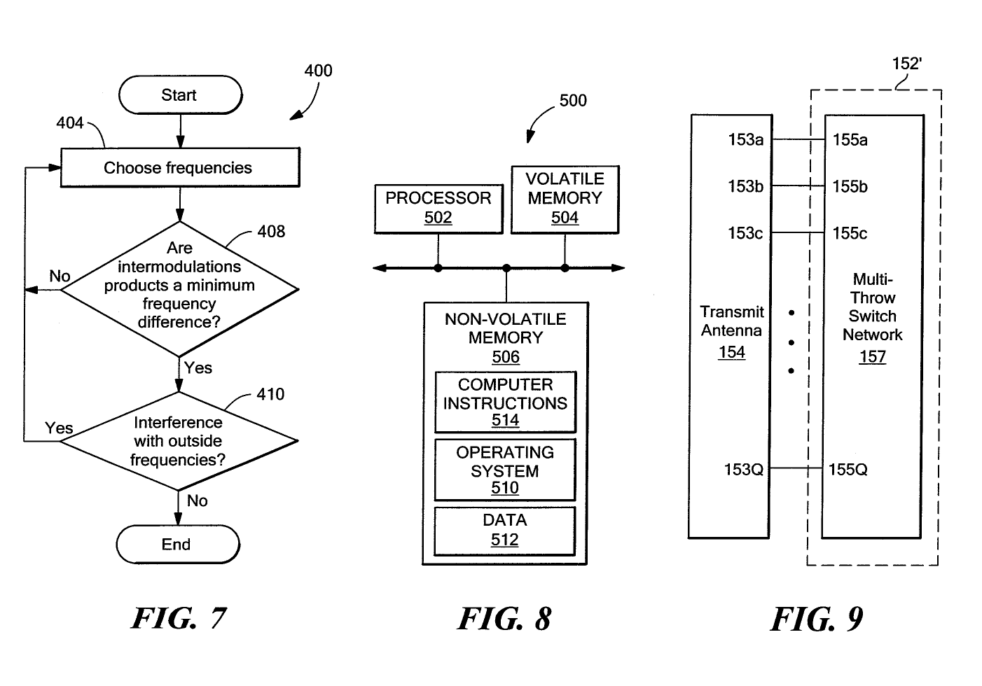

Referring to FIG. 7, as discussed above, selection of certain frequencies for the up- and down-conversion (i.e., the frequencies of the first and second LO signals) in a system which utilizes two or more down-conversions in a receiver and one or more up-conversions may further reduce undesirable coupling of signal(s) between two or more signal paths. Process 400 is an exemplary process for selecting frequencies for up- and down-conversion circuits which results in reduced interference between transmit and receive. Process 400 arbitrarily chooses frequencies (404) whose sum equals a desired transmission frequency. For example, if 24 GHz is the desired transmission frequency, and the receive system is a double-down-conversion system, then 17 GHz and 7GHz; 16 GHz and 8 GHz; 15 GHz and 9 GHz; 17.5 GHz and 6.5 GHz and so forth may be chosen. It should be appreciated that if more than two down-conversions are used in the receiver, then it may be necessary to choose more than two frequencies. Regardless of the number of frequencies selected, the sum must equal a desired transmit frequency.

Process 400 determines if the intermodulation products of the selected signal frequencies have a frequency difference corresponding to a minimum frequency difference from a desired transmission frequency (408). If two frequencies are selected, the intermodulation products may be represented by the following:
nf₁+mf₂
where f₁, represents the frequency of a first LO signal, f₂ represents the frequency of a second LO signal, and n and m are integers representing harmonics of the first and second LO signal frequencies.

If the desired minimum frequency difference between the transmit frequency and the frequency of any intermodulation product is 3 Ghz and the desired transmission frequency is 24 GHz then the intermodulation products may not be less than 27 Ghz or greater than 21 Ghz. Thus, frequencies of f₁=19 GHz and f₂=5 GHz would not be acceptable frequencies because when n=2 and m=−3, an intermodulation product of 23 Ghz is generated, which is less than 3 Ghz from the desired transmission frequency of 24 GHz. On the other hand, frequencies of f₁=17.5 GHz and f₂=6.5 GHz would be acceptable frequencies because the closest intermodulation product to the desired transmission frequency is 28.5 Ghz which occurs when n=2 and m=−1. If the intermodulation product for the two chosen frequencies are within a minimum frequency difference from the desired transmission frequency, process 400 chooses a different combination of frequencies (404).

If the chosen frequencies are not with the minimum frequency difference, process 400 determines if the frequencies interfere with outside frequency sources (410). For example, the intermodulation products of the two frequencies may interfere with frequencies used by government agencies or scientists (e.g., radio astronomers). Alternatively, the frequencies may fall within a frequency range prohibited from use by a government entity. If the frequencies do interfere with outside frequencies or fall within an un-permitted frequency range, process 400 chooses another combination of frequencies (404).

FIG. 8 shows a computer 500 using processes 300 and 400. Computer 500 includes a processor 502, a volatile memory 504 and a non-volatile memory 506 (e.g., hard disk). Non-volatile memory 506 stores operating system 510 which are executed by processor 502 out of the volatile memory 504 to perform processes 300 and 400.

Processes 300 and 400 are not limited to use with the hardware and software of FIG. 8; rather processes 300 and 400 may find applicability in any computing or processing environment and with any type of machine that is capable of running a computer program. Processes 300 and 400 may be implemented in hardware, software, or a combination of the two. Processes 300 and 400 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processes 300 and 400 and to generate output information.

The system may be implemented, at least in part, via a computer program product (i.e., a computer program tangibly embodied in an information carrier (e.g., in a machine-readable storage device or in a propagated signal, for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform processes 300 and 400. Processes 300 and 400 may also be implemented as a machine-readable storage medium, configured with a computer program, where upon execution, instructions in the computer program cause the computer to operate in accordance with processes 300 and 400.

The processes described herein are not limited to the specific embodiments described herein. For example, the processes are not limited to the specific processing order of FIGS. 5 and 7. Rather, any of the processing blocks of FIG. 5 and FIG. 7 may be re-ordered, repeated, combined or removed, performed in parallel or in series, as necessary, to achieve the results set forth above. The number of received beams is not constrained to twelve total receive beams but may be any number of receive beams. While the system herein describes processing a subset of the total number of receive beams concurrently, all the receive beams may be processed concurrently. For example, for Z receive beams there may be Z receiver channels to process the signals. The frequencies used for the emitted and received signals (e.g., 24 GHz) are examples. Other frequencies may be used for particular applications.

Referring to FIG. 9, in other embodiments, a transmitter 152′ which may be the same as or similar to the transmitter 152 (FIG. 3) may be configured in a similar fashion as the receiver 158. For example, the transmitter 152′ may include a multiple-throw switch network (MTSN) 157 that forms multiple transmit beams for transmission by the antenna 154. The MTSN 157 includes output ports 155a-155Q. The MTSN output ports 155a-155Q are coupled to the transmit antenna 154 at respective ones of antenna input ports 153a-153Q. Thus, each of the MTSN output ports 155a-155Q is coupled to a corresponding one of the antenna input ports 153a-155Q. The number of transmit beams need not be identical to the number of receive beams. For example, if there is twelve receive beams, one may have four transmit beams, each of which could cover the same field of view formed by the sum of the fields of view of three out of the twelve receive beams. In another example, a one-to-one correspondence may be formed (e.g., twelve transmit beams and twelve receive beams). It should be appreciated that the above description of the MTSN 157 as being part of the transmitter 152′ is somewhat arbitrary. That is, in some embodiments, the MTSN 157 may be considered as part of the transmit antenna 154. Alternatively still, in some embodiments, the MTSN 157 may be provided as physically separate circuit.

While two SOD systems 14, 15 are shown in FIGS. 1 and 2, the system 50 may include any number of SOD systems, including a single SOD system. While the alert displays 82, 86 are shown to be associated with side-view mirrors, the alert displays may be provided in a variety of ways. For example, in other embodiments, the alert displays may be associated with a rear view mirror (not shown). In other embodiments, the alert displays are audible alert displays.

While the CAN bus 66 is shown and described, it will be appreciated that the SOD systems 14, 15 may couple through any of a variety of other busses within the vehicle 12, including, but not limited to, an Ethernet bus, and a custom bus.

The system described herein is not limited to use with the hardware and software described above. The system may be implemented in digital electronic circuitry, or in computer hardware, firmware, software, or in combinations thereof.

While three circuit boards 102, 150, 156 are described herein, the SOD system 14 may be provided on more than three circuit boards. Also, the three circuit boards 102, 150, 156 may be comprised of other materials than described herein.

Method steps associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data.

The system is not limited to the specific examples described herein. For example, while the system described herein is within a vehicle radar system, the system may be used in any vehicle system requiring the evaluation of power supply interference. While fast Fourier transforms (FFTs) are described below, which perform a conversion of time domain signals to the frequency domain, a variety of other transforms may be used, for example, discrete Fourier transforms (DFTs).

Elements of different embodiments described herein may be combined to form other embodiments not specifically set forth above. Other embodiments not specifically described herein are also within the scope of the following claims.

What is claimed is:

1. A method of processing signals in a vehicle radar system, the method comprising:
selecting first ones of a plurality of receive beams provided by a receive antenna system; and
coupling RF signals in each of the selected receive beams to a corresponding one of a plurality of channels in a multi-channel receiver; and
concurrently processing information in each of the RF signals in the plurality of channels.

2. The method of claim 1 wherein concurrently processing information comprises down-converting the RF signals concurrently.

3. The method of claim 1 wherein
selecting first ones of a plurality of receive beams comprises selecting four antenna beams;
coupling RF signals in each of the selected receive beams to a corresponding one of a plurality of channels in a multi-channel receiver comprises coupling RF signals from each of the four receive beams to a corresponding one of four receiver channels; and
concurrently processing information in each of the RF signals in the plurality of channels comprises concurrently processing information in each of the four receiver channels.

4. The method of claim 1, further comprising transmitting a plurality of transmit beams.

5. The method of claim 4 wherein each of the plurality of receive beams corresponds to a respective one of the plurality of transmit beams.

6. The method of claim 4 wherein the quantity of the plurality of transmit beams is less than the quantity of the plurality of receive beams.

7. The method of claim 4 wherein the quantity of the plurality of transmit beams is more than the quantity of the plurality of receive beams.

8. A vehicle radar system comprising:
a receive antenna system adapted to concurrently generate a first plurality of RF antenna beams; and
a multi-channel RF receiver having a second plurality of RF receiver channels with each of the RF receiver channels coupled to receive RF signals from said antenna system wherein the RF signals are received in at least some of the first plurality of RF antenna beams and wherein the received RF signals are concurrently processed in each of the second plurality of RF receiver channels.

9. The vehicle radar system of claim 8 wherein the antenna system simultaneously provides multiple RF antenna beams for use in an amplitude only detection system.

10. The vehicle radar system of claim 8 wherein the number of RF antenna beams equals the number of RF receiver channels.

11. The vehicle radar system of claim 8 wherein the number of RF antenna beams is not equal to the number of RF receiver channels.

12. The vehicle radar system of claim 8 wherein the number of RF antenna beams is greater than the number of RF receiver channels.

13. The vehicle radar system of claim 8 wherein the number of RF antenna beams is less than the number of RF receiver channels.

14. The vehicle radar system of claim 8 wherein said multi-channel receiver comprises four receiver channels.

15. The vehicle radar system of claim 8 wherein said antenna system provides twelve antenna beams.

16. The vehicle radar system of claim 8, further comprising a beam selection circuit disposed to couple each of the first plurality of RF antenna beams provided by said antenna system to at least one of the second plurality of RF receiver channels.

17. The vehicle radar system of claim 8 wherein each RF receiver channel comprises:
a first frequency down-converter circuit; and
a beam selection circuit having a third plurality of input ports and an output port with each of the beam selection circuit input ports coupled to receive RF signals from one or more of the first plurality of RF antenna beams and the beam selection circuit output port is coupled to a first port of the first frequency down-converter circuit.

18. The vehicle radar system of claim 17 wherein the beam selection circuit comprises a multiplexer.

19. The vehicle radar system of claim 8 wherein said antenna system comprises:
an antenna having a plurality of antenna output ports; and
a beam-former circuit having a plurality of input ports and a plurality of beam ports with each of the input ports coupled to corresponding ones of the antenna output ports and each of the beam ports coupled to at least one RF receiver channel in said multi-channel receiver.

20. A receiver in a radar system, comprising:
a first multiplexer receiving a first set of receive beams from a beam-former circuit;
a second multiplexer receiving a second set of receive beams from the beam-former circuit, the first set of receive beams and the second set of receive beams representing a same moment in time;
a first channel for down-converting the first set of receive beams, the first channel being connected to the first multiplexer; and
a second channel for down-converting the second set of receive beams, the second channel being connected to the second multiplexer.

21. The receiver of claim 20, wherein the first channel comprises a first down converter.

22. The receiver of claim 21, wherein the first channel includes a second down converter.

23. The receiver of claim 20, further comprising:
a first set of low noise amplifier (LNA), each LNA of the first set of LNAs receiving a corresponding receive beam from the first set of receive beams and coupled to the first multiplexer; and
a second set of LNAs, each LNA of the second set of LNAs receiving a corresponding receive beam from the second set of receive beams and coupled to the second multiplexer.

24. A vehicle detection system comprising:
a transmitter comprising a multi-throw switch network, the multi-throw switch network configured to provide a plurality of transmit beams; and
a transmit antenna configured to transmit the plurality of transmit beams.

25. The vehicle detection system of claim 24, further comprising a receive antenna system configured to generate a plurality of receive beams.

26. The method of claim 25 wherein each of the plurality of receive beams corresponds to a respective one of the plurality of transmit beams.

27. The method of claim 25 wherein the quantity of the plurality of transmit beams is less than the quantity of the plurality of receive beams.

28. The method of claim 25 wherein the quantity of the plurality of transmit beams is more than the quantity of the plurality of receive beams.
